(19) United States
(12) Patent Application Publication
(10) Pub. No.: US 2019/0061091 A1
(43) Pub. Date: Feb. 28, 2019

(54) DEVICE FOR IN-CONTAINER OPERATIONS

(71) Applicant: Wabash National, L.P., Lafayette, IN (US)

(72) Inventor: Caleb Schmitz, Fond du Lac, WI (US)

(21) Appl. No.: 16/117,242

(22) Filed: Aug. 30, 2018

Related U.S. Application Data
(60) Provisional application No. 62/552,509, filed on Aug. 31, 2017.

(51) Int. Cl. B24B 5/40; B24B 27/00; B24B 41/02; B23K 37/02; B60B 19/12; B60B 19/00

(52) U.S. Cl. CPC B24B 5/40; B24B 27/0038; B24B 27/0076; B24B 41/02; B23K 2101/04; B60B 19/125; B60B 19/003; B60Y 2200/60; B23K 37/0276

(57) ABSTRACT

A processing device is configured for use within a storage container with an interior surface. The processing device can include a chassis with one or more support assemblies. The chassis can support one or more motive assemblies, which can be configured to engage the interior surface for movement of the chassis relative to the interior surface. The one or more support assemblies can be configured to support one or more tools, with the one or more tools being configured to execute one or more processes on the interior surface when the processing device is within the storage container.

### CROSS-REFERENCE TO RELATED APPLICATIONS

This application claims priority under 35 U.S.C. § 119 to U.S. Provisional Patent Application No. 62/552,509, filed Aug. 31, 2017, entitled “Device for In-Container Operations,” the entire contents of which are incorporated herein by reference for all purposes.

### FIELD OF THE DISCLOSURE

The present disclosure relates generally to tools for executing different operations within storage containers, including within cylindrical mobile cargo tanks and cylindrical stationary storage tanks. In particular, embodiments of the disclosure can be used for surface treatments, such as grinding, on the interior surfaces of different storage containers.

### BACKGROUND

During the manufacture and maintenance of storage containers, (e.g., cylindrical or other mobile cargo tanks) different operations may need to be executed within the containers. Generally, these operations can be considered “in-container” operations, and can include grinding, polishing, and cleaning, for example. Under conventional approaches, workers may need to be physically disposed within the relevant container, and may need to directly manually hold and manage the relevant tool(s). Particularly for containers with smaller dimensions and non-flat walls (e.g., cylindrical mobile cargo tanks), these or other factors can cause the relevant operations to be difficult, time-consuming, and otherwise undesirable.

### SUMMARY

Embodiments of the invention can provide a device to support a tool for automated, semi-automated, or entirely manual execution of manufacturing, maintenance, and other operations within tanks, including grinding and polishing of weld seams and heat tint.

According to some aspects of the invention, a processing device can be configured for use within a storage container with an interior surface. A chassis can include one or more support assemblies. One or more motive assemblies can be supported by the chassis and can be configured to engage the interior surface for movement of the chassis relative to the interior surface. The one or more support assemblies can be configured to support one or more tools, and the one or more tools can be configured to execute one or more processes on the interior surface when the processing device is within the storage container.

According to some aspects of the invention, a processing device can be configured for use with a cylindrical storage tank with an interior surface. A chassis can include a plurality of leg assemblies and a support assembly, with the support assembly being configured to support at least one tool for in-tank operation. A plurality of motive assemblies can be supported by the leg assemblies and can be configured for movement of the chassis relative to the interior surface. The processing device can be configured to be movably disposed within the cylindrical storage tank. The leg assemblies can be configured to extend and to retract, to selectively engage the motive assemblies with the interior surface. The motive assemblies, when engaging the interior surface, can support the at least one tool, via the chassis, for executing one or more in-tank processes on the interior surface.

According to some aspects of the invention a method is provided for using a processing device to perform a process in a cylindrical storage tank that has an interior surface, where the processing device including a chassis, a support assembly that supports a tool, and a plurality of leg assemblies that support one or more motive assemblies. The chassis can be disposed within the cylindrical storage tank. The plurality of leg assemblies can be adjusted to engage the one or more motive assemblies with the interior surface. The support assembly can be adjusted to operatively engage the tool with the interior surface. The processing device can be moved within the cylindrical storage tank to move the tool relative to the interior surface

These and other features of the present disclosure will become more apparent from the following figures and description of example embodiments.

### BRIEF DESCRIPTION OF THE DRAWINGS

FIG. 1 is an isometric view of an in-container processing device, according to an embodiment of the invention, with a tank to receive the in-container processing device partially illustrated;

FIG. 2 is another isometric view of the in-container processing device and partially illustrated tank of FIG. 1;

FIG. 3 is an enlarged partial isometric view of the in-container processing device and partially illustrated tank of FIG. 1, including leg assemblies, motive assemblies, and a support assembly for a tool;

FIGS. 4 and 5 are enlarged partial isometric views of the in-container processing device and partially illustrated tank of FIG. 1, including one of the leg assemblies and one of the motive assemblies of FIG. 3; and

FIG. 6 is a partial perspective view of the interior of the tank of FIG. 1.

### DETAILED DESCRIPTION

For the purposes of promoting an understanding of the principles of the disclosure, reference will now be made to example embodiments shown in the attached drawings and specific language will be used to describe the same. However, before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. For example, while some concepts of this disclosure are described below in relation to a cylindrical cargo tank, it will be understood that these and other concepts may also be applied in the context of other storage containers, including other mobile or stationary storage containers.

Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items, as appropriate.

Unless otherwise specified or limited, the phrases “at least one of A, B, and C,” “one or more of A, B, and C,” and the like, are meant to indicate A, or B, or C, or any combination of A, B, and/or C, including combinations with single or multiple instances of A, B, and/or C. Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, the term “cylindrical” is used to refer to containers that have generally rounded interior walls. As such, for example, a cylindrical mobile cargo tank can exhibit a fully circular cross-section, an oval (e.g., elliptical) cross section, or other similar cross-sections. Further, unless otherwise specified or limited, a “cylindrical” container need not necessarily exhibit a constant cross-sectional profile. As such, for example, some cylindrical tanks can include conical portions or other varying geometry.

As noted above, conventional approaches to in-container processes can be relatively inefficient and costly, and may rely on a worker's physical presence within the relevant container, along with manual support and operation of the relevant tool. Embodiments of the invention, including those expressly discussed below, can address one or more of these (or other) issues.

Generally, a device according to the invention can include a chassis configured to support itself within a container for one or more operations. In some embodiments, the chassis can include support members for one or more motive components (e.g., wheel assemblies) that can movably support the chassis relative to the walls of the container. The chassis can also include a support structure for one or more tools, which can be used to execute particular manufacturing or other (e.g., cleaning or maintenance) operations within the container. In some embodiments, the motive components and/or the one or more tools can be configured to operate autonomously, or semi-autonomously. For example, embodiments of the invention may be configured to move (actively or passively) within a container and execute different manufacturing (or other) operations autonomously, or as guided by an operator who is physically outside of the container. In some embodiments, the motive components or the one or more tools can be configured to be operated manually. In some embodiments, the motive components or the one or more tools can be controlled by an operator who is physically inside of the container.

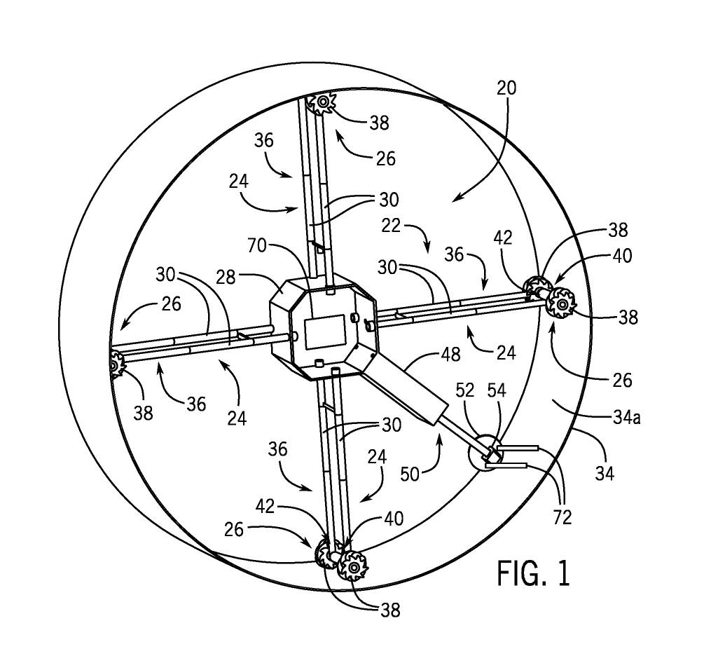

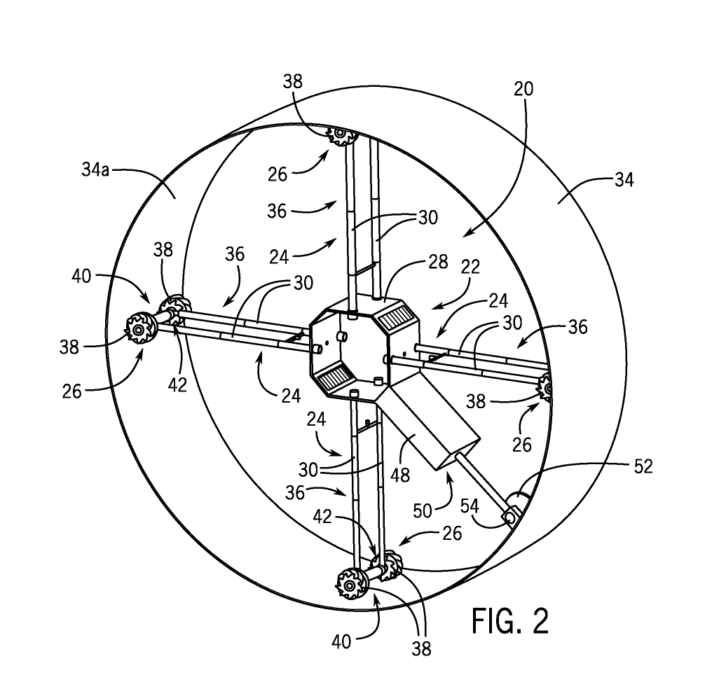

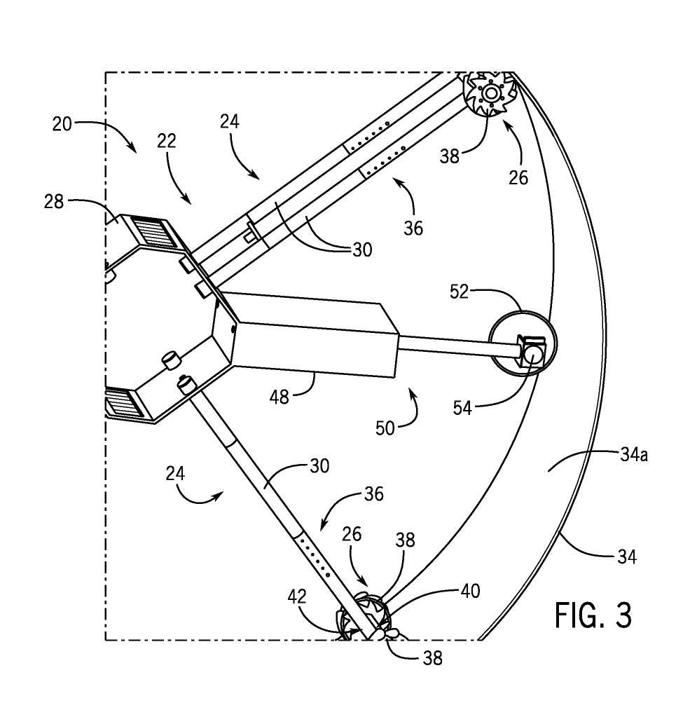

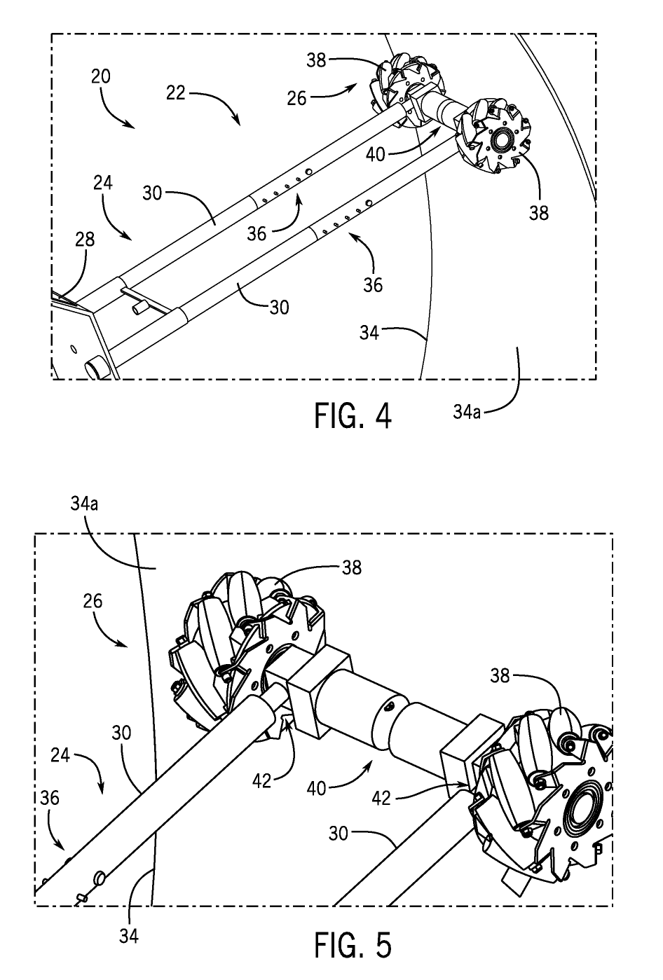

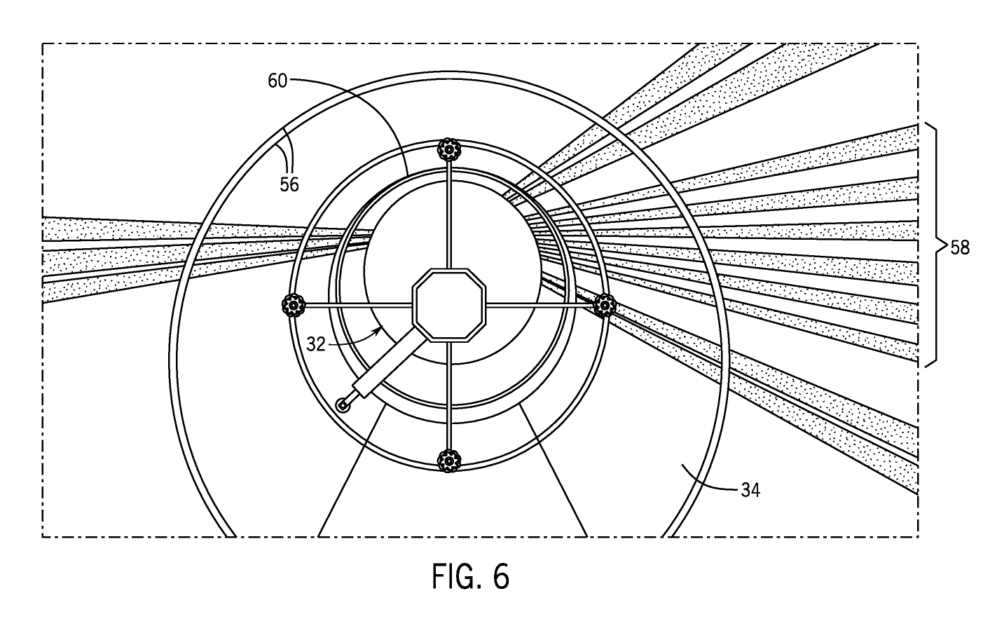

FIGS. 1-5 illustrate an example in-tank processing device 20 according to an embodiment of the invention. In the embodiment illustrated, the device 20 is configured for use to execute grinding and polishing operations within a cylindrical mobile cargo tank, such as a cylindrical tank 34, as illustrated in FIG. 6 in particular. Accordingly, some examples discussed below focus in particular on this context. In other embodiments, an in-container processing device can be configured to execute the same or different operations in any variety of containers, including non-cylindrical containers and stationary containers.

Generally, the device 20 includes a chassis 22 configured to support itself, as well as one or more tools, relative to interior walls of a container, such as the tank 34. In the embodiment illustrated in FIGS. 1-5, the chassis 22 includes a set of leg assemblies 24, each of which connects a motive assembly 26 to a common central structure 28. In the embodiment illustrated, the central structure 28 is configured as a rigid electrical box, which can provide structural strength to the chassis 22, as well as house electronics and other equipment. In other embodiments, other configurations are possible.

Generally, it may be useful for the leg assemblies 24 of a chassis according to the invention to be adjustable, extendable, retractable, collapsible, modular, and/or otherwise configured to enable insertion of a device into a relatively small opening in a relevant container (e.g., a manhole in a tank). In the embodiment illustrated, each of the leg assemblies 24 includes a pair of telescoping legs 30, which are detachably secured to the central structure 28. Accordingly, the leg assemblies 24 can be detached from the central structure 28 in order for the device 20 to be moved through a manhole 32 in the tank 34 (see FIG. 6), then re-attached to the central structure 28 in order to execute different operations within the tank 34.

In other embodiments, other configurations are possible. For example, part or all of one or more of the leg assemblies 24 can hinge relative to the central structure 28. With the leg assemblies 24 hinged, the device 20 can be moved through the manhole 32 (or other relatively small opening) without removing the leg assemblies 24 from the device 20. As another example, part or all one or more of the leg assemblies 24 can collapse (e.g., via an accordion-style linkage (not shown)) or otherwise retract to allow the device 20 to pass through the manhole 32 or another container opening.

In the embodiment illustrated, the telescoping legs 30 are manually movable between predetermined lengths and are securable at particular lengths by pin arrangements 36 (see FIGS. 1-3). In some embodiments, the legs 30 can be configured to telescope automatically (e.g., as driven by linear actuators), or to telescope to any desired length along a continuous range. In some embodiments, the legs 30 can be spring-loaded or otherwise biased to extend in a radially outward (or other) direction.

Configurations with variable-length leg assemblies (e.g., as illustrated for the leg assemblies 24) can be useful for moving the device 20 into position for different processes, as noted above, and can allow the device 20 to accommodate different sizes and/or shapes of containers. For example, in some implementations, the leg assemblies 24 can be adjusted to different lengths in order to support the chassis 22 relative to the interior surfaces of containers having different internal dimensions (e.g., different internal diameters). Similarly, the leg assemblies 24 can be adjusted to different lengths to accommodate containers with different overall geometries (e.g., oval or non-cylindrical tanks). In some implementations, the leg assemblies 24 can also be adjusted to different lengths to accommodate changes in geometry within individual containers. For example, the leg assemblies 24 can be adjusted at various times within a conical tank (not shown) in order to allow execution of relevant processes at portions of the tank having different internal diameters.

As also noted above, it can be useful to include motive assemblies, such as the motive assemblies 26 at the ends of the leg assemblies 24. Generally, in different embodiments, a motive assembly, such as the motive assemblies 26, can enable a particular in-container processing device to move within a relevant container in order to execute processes at different locations within the container. In some embodiments, motive assemblies can include powered devices, such as powered wheels, or other similar arrangements. In some embodiments, motive assemblies may be non-powered assemblies, such as casters, slides, or other movable mechanical supports.

In the embodiment illustrated, each of the motive assemblies 26 includes a set of Mecanum (or “Ilum”) wheels 38 with associated motor assemblies 40. Employing different control approaches, each of the sets of the wheels 38 can be actuated with the motor assemblies 40 to drive the associated leg assembly 24 (and the chassis 22 as a whole) in any direction along an interior wall 34a of the tank 34 (e.g., circumferentially, axially, or a combination of the two). In this way, for example, the device 20 can be generally translated and/or rotated within the tank 34 along any number of relevant paths. For example, the device 20 can be rotated circumferentially, as may be useful to execute processing on a circumferential feature (e.g., a circumferential weld seam), then translated axially, as may be useful to execute processing on an axial feature (e.g., an axial line of heat tint), then moved in a helical (i.e., circumferential and axial) movement in order to execute further processing (e.g., cleaning or polishing).

In the illustrated embodiment, the interior wall 34a forms a substantially continuous and generally smooth interior surface. In other implementations, an interior surface that can support the device 20, or that can be processed (e.g., ground) by the device 20, can exhibit other geometry. For example, some interior surfaces can exhibit discontinuities or non-smooth contours.

Also in the illustrated embodiment, each of the wheels 38 exhibits approximately a 4 inch diameter and is configured to support at least 50 pounds of force. In other embodiments, other sizes or force capacities are possible. For example, where processes with relatively large force requirements (e.g., planishing) are to be implemented, larger wheels or larger force capacities may be appropriate.

In some embodiments, the wheels 38 can be formed from, or coated with, select materials, in order to avoid inadvertent damage to the interior wall 34a or other features of relevant containers. For example, the wheels 38 can be formed from urethane or other rubber, or coated with polytetrafluoroethylene (PTFE), including Teflon® brand material or other substances. (Teflon is a registered trademark of the Chemours Company in the United States and/or other jurisdictions.)

Other configurations are also possible. In some embodiments, the Mecanum wheels 38 (or other types of wheel systems) can be are provided on only a subset of the leg assemblies 24. For example, sets of the Mecanum wheels 38 can be provided on two of the leg assemblies 24, and castors or other wheel (or non-wheel) systems can be provided on the remaining leg assemblies 24. Similarly, in some embodiments, a set of Mecanum wheels for a particular leg assembly may include only a single wheel, rather than multiple wheels.

In some embodiments, Mecanum wheels may be excluded entirely. For example, one or more of the leg assemblies 24 can be equipped with steerable castor wheels (e.g., as controlled by dedicated servo motors) or other assemblies (not shown), in order to thereby control the direction of movement of the device 20 within a container.

In some embodiments, a different number of leg assemblies can be provided, which may sometimes correspond to a different number or arrangement of motive assemblies. For example, some embodiments with three leg assemblies (e.g., instead of the four leg assemblies 24), may include only three sets of Mecanum wheels, or two sets of Mecanum wheels (e.g., in combination with a caster or other wheel system).

In the embodiment illustrated, each of the Mecanum wheels 38 is provided with a dedicated one of the motor assemblies 40, with two separate motors. In other embodiments, other configurations are possible. For example, a smaller number of the motor assemblies 40 can be provided with one or more transmissions (e.g., belt transmissions) (not shown) configured to transfer power from a particular one of the motor assemblies 40 to a plurality of the Mecanum wheels 38 (or other wheel arrangements). Similarly, in some embodiments, one or more motor assemblies can be provided at other locations (e.g., within the central structure 28) with one or more transmissions (not shown) being configured to transfer power from the motor assemblies to one or more of the motive assemblies 26.

In some embodiments, it may be useful to provide the leg assemblies 24 with a suspension system. For example, in the embodiment illustrated, each of the leg assemblies 24 includes a passive, spring-biased suspension 42. The suspension 42 extends from the motive assemblies 26 into the interior of the respective telescoping legs 30. This may be useful, for example, to accommodate variations in forces on the chassis 22 (e.g., due to ongoing execution of different processing by the device 20), as well as to accommodate variations in the internal geometry of the relevant container (e.g., variations from perfectly circular or oval geometry, or other variations in interior wall profiles).

In some embodiments, a suspension can be configured differently than the suspensions 42. For example, a suspension for one or more of the motive assemblies 26, the leg assemblies 24, or other subsystems of the device 20 can be configured as an active (e.g., actively controlled) suspension.

In some embodiments, a suspension can be configured to complement other adjustment mechanisms for the device 20. In the embodiment illustrated, for example, the spring-biased suspensions 42 can provide a distance of permitted travel for the motive assemblies 26 that generally complements the length-adjustment intervals provided by the pin arrangements 36. For example, the suspensions 42 can allow the motive assemblies 26 to move a distance that is appropriately complementary to (e.g., approximately equal to or greater than) the distance between pin holes in the pin arrangements 36, so that the pin arrangements 36 and the suspensions 42 can together accommodate any desired length of the different leg assemblies 24 within a particular range.

As also noted above, embodiments of the invention can be configured to support one or more tools in order to execute one or more processes within a particular container. Generally, such tools can be configured for execution of any number of in-container processes, including grinding, polishing, cleaning, peening, welding, inspection, and so on.

To support one or more tools, embodiments of the invention can generally include appropriate support assemblies, which can be configured as distinct assemblies from associated leg assemblies. As illustrated in FIGS. 1-5, for example, the chassis 22 includes a support assembly 50, which is distinct from the leg assemblies 24, and is generally configured to support a tool for execution of one or more in-tank processes. In the embodiment illustrated, as also discussed below, the support assembly 50 is configured to support a grinder 52 on an articulating support 54. In other embodiments, other configurations are possible.

Generally, it may be useful to configure a support assembly for a tool so that the tool may be controllably moved, as may be appropriate for execution of different in-container processes. In the embodiment illustrated, for example, the support assembly 50 includes a linear actuator 48 configured to controllably move the grinder 52 (or another attached tool) radially toward and away from the interior wall 34a. In this way, for example, the grinder 52 can be controllably moved into engagement with the interior wall 34a for selective grinding operation. Further, with appropriate control electronics (or other control systems), appropriate contact force between the grinder 52 and the interior wall 34a can be maintained, in order to ensure appropriate finishing of relevant portions of the wall 34a. The linear actuator 48 can be configured to include a piston and cylinder arrangement (e.g., a hydraulic or pneumatic system) or any number of other arrangements.

Other configurations are also possible. For example, some support assemblies 50 can be configured to move supported tools in other ways, including circumferentially, axially, helically, or at an angle relative to a plane defined by one or more of the leg assemblies.

As also illustrated in FIGS. 1-3, the support assembly 50 includes an articulated support 54, which can be controlled to pivot, rotate, or otherwise selectively move the grinder 52 (or another tool) to different orientations and otherwise selectively position the grinder for operation. For example, the support 54 can pivot the grinder 52 into different orientations to grind in different directions or at different angles, and can also move along or around the relevant container without grinding. In some embodiments, the support 54 can be manually controlled to orient the grinder 52 (or another tool). In some embodiments, the support 54 can be automatically controlled, such as through computerized control of one or more servo motors (not shown).

In some embodiments, the support assembly 50 can be configured to support multiple tools. For example, in some embodiments, the support 54 can be configured to selectively release the grinder 52 so that a different tool (not shown) can be attached instead. As another example, an automated or otherwise moveable support (not shown) on the support assembly 50 can be configured to simultaneously support a set of multiple tools, such as a set of multiple grinders (e.g., including the grinder 52) with different grits or other characteristics. This may be useful, for example, so that multiple grinding passes over a particular feature can be executed without needing to swap grinders in and out of service. For example, a first grinding pass can be executed using the grinder 52, then the support 54 can be controlled to move one or more different grinders (not shown) into engagement for a subsequent grinding pass or passes.

In some embodiments, multiple support assemblies can be provided on the chassis 22. For example, in addition to the support assembly 50, another support assembly (not shown) can also be attached to the central structure 28. In this way, for example, it may be possible to execute multiple operations simultaneously, to execute a single operation with simultaneous implementation of multiple tools, or otherwise increase the flexibility of the device 20 (or other devices according to the invention). For example, a second support assembly 50 could be positioned opposite the first support assembly 50 (e.g., 180 degrees offset about the chassis 22). Two tools (e.g., identical grinders 52) can be coupled to either support assembly, such that 180 degree rotation, rather than full 360 degree rotation, is sufficient to carry out certain processes (e.g., grinding). Accordingly, for example, orientations with multiple support assemblies 50 can potentially reduce the amount of time required to carry out a desired container processing operation.

In some embodiments, other tool configurations are possible. As one example, the device 20 can be configured to support multiple grinders that are arranged to move in parallel and with a constant offset (e.g., 3 inches on center). This can be useful, for example, in order to grind features such as weld tint lines from support rings on mobile cargo tanks (e.g., tint lines 56 as illustrated in FIG. 6), which can extend circumferentially and in parallel around the interior of the tanks. As another example, a set of grinders can be supported to grind along multiple longitudinal welds, such as the six longitudinal welds 58 from attachment of heat channels that are illustrated in FIG. 6.

As another example, the device 20 can be configured to support a cleaning system (not shown). For example, the support assembly 50 can be configured to support an air line to blow pressurized air near the motive assemblies 26, in order to clear debris from the path of the motive assemblies 26 and thereby protect the interior wall 34a from potential damage. In some embodiments, other cleaning systems can be included, such as cleaning systems capable of suction, and cleaning systems configured to clean large interior areas of a particular container.

As further examples, the device 20 can be configured to support carbide tools for peening (e.g., of a center weld seam 60 illustrated in FIG. 6, or of head seams (not shown)), wide buffing heads to finish large areas on the inside of a container (e.g., to remove latex or other staining), welding equipment (e.g., a purge weld head), and so on. Likewise, the device 20 can be configured to support inspection equipment, such as ultrasonic or other thickness test equipment, profilometers to inspect surface roughness, pit inspection devices (e.g., to detect pitting from chloride or fluoride), and so on. In some embodiments, other surface-processing equipment can be included, such as passivation systems or other devices.

In some embodiments, different tools (e.g., as listed above) can be supported simultaneously on the relevant device (e.g., the device 20), including on the same or different support assemblies (e.g., the support assembly 50). In some embodiments, the relevant devices (e.g., the device 20) can be configured to allow relatively easy swapping of tools (or support assemblies) for execution of different in-container processes.

Operation of devices according to the invention, including movement of the device(s) and operation of the relevant tool(s) can be controlled in a variety of ways. In some embodiments, control can be automated, semi-automated, or entirely manual (e.g., via direct mechanical interaction with the device or components thereof). In some embodiments, control devices (e.g., on-board computing devices, such as a controller 70 illustrated in FIG. 1) can be configured to receive input from one or more input devices and automatically control movement of the motive assemblies 24, the telescoping legs 30, and/or the grinder 52 (or other tool) accordingly. In this regard, for example, relevant input can be received from input devices configured as surface probes or other contour or surface sensors (not shown), distance or proximity sensors, cameras (e.g., imaging devices paired with machine vision software), and so on. Likewise, in some configurations, relevant input can be received from other input devices such as worker-operated remote (or other) controls, gyroscopes, accelerometers, computing systems disposed outside of the relevant container, and so on.

In some embodiments, a set of two distance sensors 72 (see FIG. 1) can be provided to help control the use of the grinder 52 (or other tool). In some embodiments, gyroscopes or other devices can be included to provide control signals for movement of the device 20 as a whole, or for portions thereof. In some embodiments, a different number or configuration of sensors is possible.

In keeping with the discussion above, in the device 20, the central structure 28 can generally serve as a control box, which can house relevant control electronics, including computing devices (e.g., the controller 70), wired or wireless communication devices, input/output devices for communication with a user or external system (e.g., a remote server), connections for sensors of various kinds, and so on. In some embodiments, the central structure 28 can also support power sources, such as attachments for external power conduits (not shown), battery packs (not shown), and so on.

In some embodiments, the device 20 can operate under partial or full guidance from an operator—i.e., may be partly automated or fully manual. For example, an operator can remotely control the device 20, or subsystems thereof, from outside of the relevant container, via wired or wireless commands, including as based on information received via video or other feeds. As another example, an operator can control the device 20, or subsystems thereof, from within the relevant container. For example, an operator can stand (or walk) near the device 20 as the device 20 operates, controlling aspects of the operation of the device 20 (e.g., use of a tool or movement of the device 20) with an electronic remote control, or via direct mechanical (e.g., manual) interaction with the device 20 or a mechanical controller thereof

In some embodiments, the device 20 may not include motorized wheels, such that an operator may generally need to manually move the device 20 within a container. For example, an operator may directly push, pull or rotate the device 20 within a container, or may move the device 20 using a mechanical device such as a crank.

In cases where the device 20 is controlled by an operator, remote or other controls (not shown) may be provided for any number of functions. For example, in addition to controls for movement of the chassis 22 (e.g., as discussed above), controls may be provided for operation of relevant tools (e.g., to control tool selection, tool pressure, tool power and speed settings, or other tool parameters), of the support assembly 50 (e.g., to control tool location and pressure), or of other subsystems of the device 20.

In some embodiments, the device 20 can be configured for mechanically (or otherwise) guided movement. For example, rails or other similar features (not shown) can be installed within a relevant container in order to guide movement of the device 20. In some embodiments, accordingly, linear bearings or other similar structures can be provided on the chassis 22, in order to guide movement of the device 20.

Thus, embodiments of the invention may provide improved devices for in-container processes, including in-tank grinding, relative to conventional approaches. For example, embodiments of the invention can provide a chassis and associated support and motive systems to support and move one or more tools within a container. Accordingly, for example, different processes can be executed within the container by the one or more tools without necessarily requiring a worker to directly hold or otherwise directly manage the tool(s). Likewise, in some embodiments, different processes can be executed within the container while being controlled by a worker who is located outside the container.

While the disclosure has been illustrated and described in detail in the foregoing drawings and description, the same is to be considered as exemplary and not restrictive in character, it being understood that only example embodiments thereof have been shown and described and that all changes and modifications that come within the spirit of the disclosure are desired to be protected.

1. A processing device for use within a storage container with an interior surface, the processing device comprising:
a chassis including one or more support assemblies; and
one or more motive assemblies supported by the chassis and configured to engage the interior surface for movement of the chassis relative to the interior surface;
the one or more support assemblies being configured to support one or more tools, the one or more tools being configured to execute one or more processes on the interior surface when the processing device is within the storage container.

2. The processing device of claim 1, wherein the chassis includes one or more leg assemblies configured to support the one or more motive assemblies in engagement with the interior surface.

3. The processing device of claim 2, with the storage container including a manhole, wherein the one or more leg assemblies are configured to be at least one of telescoping, collapsible, and foldable, to pass through the manhole.

4. The processing device of claim 2, wherein the one or more leg assemblies include one or more suspensions.

5. The processing device of claim 2, wherein the one or more support assemblies to support the one or more tools are distinct from the one or more leg assemblies.

6. The processing device of claim 1, wherein the one or more motive assemblies include one or more Mecanum wheels.

7. The processing device of claim 1, further comprising:
at least one input device; and
wherein, based upon input from the at least one input device, the processing device is configured to one or more of execute the one or more processes, move axially within the storage container, and move circumferentially within the storage container.

8. The processing device of claim 1, wherein the one or more tools includes at least one of: a grinder, a cleaning system, a carbide tool, a wide buffing head, welding equipment, and inspection equipment.

9. The processing device of claim 8, wherein the one or more tools includes a plurality of grinders, with at least two of the grinders being positioned at a predetermined distance from each other and configured to simultaneously execute grinding on different portions of the interior surface.

10. The processing device of claim 1, wherein the processing device is configured to be controlled by an operator disposed within the storage container.

11. A processing device for use with a cylindrical storage tank with an interior surface, the processing device comprising:
a chassis that includes a plurality of leg assemblies and a support assembly, the support assembly being configured to support at least one tool for in-tank operation; and
a plurality of motive assemblies supported by the leg assemblies and configured for movement of the chassis relative to the interior surface;
the processing device being configured to be movably disposed within the cylindrical storage tank;
the leg assemblies being configured to extend and to retract, to selectively engage the motive assemblies with the interior surface; and
the motive assemblies, when engaging the interior surface, supporting the at least one tool, via the chassis, for executing one or more in-tank processes on the interior surface.

12. The processing device of claim 11, wherein at least one of the leg assemblies is a telescoping leg assembly with at least two telescoping legs; and
wherein at least one of the motive assemblies includes a first Mecanum wheel supported by a first one of the telescoping legs and a second Mecanum wheel supported by a second one of the telescoping legs.

13. The processing device of claim 11, for use with a grinder, the processing device further comprising:
an articulated support that is configured to secure and selectively position the grinder for a grinding operation on the interior surface.

14. The processing device of claim 11, for use with a first grinder and a second grinder, wherein the support assembly is configured to support the first and second grinders at a predetermined distance from each other to execute simultaneous grinding operations on separated portions of the interior surface.

15. The processing device of claim 11, wherein the support assembly is configured to selectively release the at least one tool to be replaced by at least one different tool.

16. A method of using a processing device to perform a process in a cylindrical storage tank having an interior surface, the processing device including a chassis, a support assembly that supports a tool, and a plurality of leg assemblies that support one or more motive assemblies, the method comprising:
disposing the chassis within the cylindrical storage tank;
adjusting the plurality of leg assemblies to engage the one or more motive assemblies with the interior surface;
adjusting the support assembly to operatively engage the tool with the interior surface; and
moving the processing device within the cylindrical storage tank to move the tool relative to the interior surface.

17. The method of claim 16, wherein moving the processing device includes rotating the processing device to move the tool circumferentially about the interior surface.

18. The method of claim 17, wherein moving the processing device further includes axially translating the processing device to helically move the tool within the cylindrical storage tank.

19. The method of claim 16, wherein the tool is a grinder.

20. The method of claim 16, with the support assembly further supporting a second tool, the method further comprising:
adjusting the support assembly to operatively engage the second tool with the interior surface; and
moving the processing device within the cylindrical storage tank to move the second tool relative to the interior surface.
